(19) United States
(12) Patent Application Publication
(10) Pub. No.: US 2010/0174700 A1
(43) Pub. Date: Jul. 8, 2010

(54) System and method to generate specific DM content for distribution

(76) Inventors: Mark Howard Krietzman, Palos Verdes Estates, CA (US); Damon Cusato, Malibu, CA (US)

Correspondence Address: Mark Krietzman;in pro per, PO Box 3185, Palos Verdes, CA, 90274, US

(21) Appl. No.: 12/655,483

(22) Filed: Jan. 2, 2010

Related U.S. Application Data
(60) Provisional application No. 61/204,185, filed on Jan. 2, 2009.

(51) Int. Cl. G06F 17/30; H04N 7/173

(52) U.S. Cl. 707/709; 725/86; 707/E17.108

(57) ABSTRACT

A content generating process wherein a broadcaster contacts a moderator and makes a request for specific media content. The moderator processes the request for media content and communicates to a population. Said communication prompts or incentivizes at least one member of a population to provide media content to a content library. Said library content may also be filtered by members of a population. The moderator in some aspects supplies media content to a broadcaster who may broadcast the collected media responsive to the request for specific content.

### PRIORITY

This application claims the benefit of U.S. provisional patent application 61/204,185 filed Jan. 2, 2009 entitled “Broadcast content generator and filter” the entirety of which (specification, claims, figures and abstract) is hereby incorporated by this reference as if fully set forth herein.

### BACKGROUND OF THE DISCLOSURE

1. Field of the Disclosure

This disclosure pertains to prompting or encouraging members of a population to provide Digital Media content for further distribution.

2. Background

Digital Media may be found and or stored on a myriad of devices containing the following types of storage including but not limited to magnetic, optical, dynamic memory, solid state memory technology stored either locally or remotely, both, buffered and streaming and on local area networks and wide area networks, wire-line and wireless.

Tens of thousands of streaming media postings (video and other forms of compressed digital or analog video or audio streams) are posted every day, and this number is increasing as the tools and opportunities for capturing content become more ubiquitous/widespread. Shared content is a burgeoning form of communication for personal, governmental, business and commercial uses.

Websites and communities such as myspace, facebook and you-tube are repositories of posted (uploaded content) which may be viewed under certain circumstances.

### SUMMARY

Digital Media “DM” includes but is not limited to non-video digital such as still digital photos, still digital graphics, buffered live footage, still photos (compressed, uncompressed such as jpeg, tiff, bitmap, RAW). Digital video content includes compressed and non-compressed digital and analog video, digital and analog audio, and digital encoding for other sense such as digital taste and digital smell.

Communication shall mean an exchange of information.

Moderator means an individual, individuals, entity or entities that have one or more content libraries accessible via wired or wireless connections.

Content library means one or more website, urls, linked websites, ftp sites, servers that contain DM content. The Content library may also carry out the Moderator function. The DM available on or through the content library is also known as “viewer accessible digital content” (VADC). VADC can be stored on or at the content library. The DM of the content library may be stored in a myriad of forms, including but not limited to buffered on one or more of a DVD, CD, hard drives, solid state drives (SSD), optical drives, flash drives, flash memory, DRAM, and DIMM, console gaming devices, digital video recorders (DVR), set top boxes, desktop or notebook computer, servers, server farms and networked devices.

Accessible as used in “viewer accessible” refers to a viewer being able to access DM content through a wired or wireless network or internet using a device such as a computer, gaming system, television or phone or other device with the ability to view DM allowing the user access to the VADC. The content library may be local (located in close proximity to the user), networked, remote.

Broadcaster means an entity that at least provides, transmits, controls, facilitates, engages in, or otherwise is involved in the delivery of a signal (which may be compressed and/or encoded) of television programming content through communication means. Communication means refers to, but is not limited to, Internet (including IPv6), cable, DSL, satellite, and/or airwaves and wireless as digital and/or analog code. A broadcaster may also serve the dual function of being the Moderator. broadcaster may also include downloadable programs such a podcasts.

Request for Specific Content “R4SC” means a request from a broadcaster for DM as a function of an identified genera, class, category, affiliation or type of content.

Request to Refine “R2R” means a suggestion from the moderator to the broadcaster suggesting a R4SC or refining a R4SC.

Call For Content “C4C” means a prompt, request solicitation, demand and/or motivational message delivered, posted, issued or otherwise announced by or from the moderator (or moderator/broadcaster) that encourages a from one or more members of the population to deliver the sought after content

Category Specific Content “CSC” is the content response provided as a function of a C4C. Provided includes linking, connecting and/or uploading content that meets a genera, class, category, affiliation or type. Encouragements (also known as rewards) may include but are not limited to financial, personal, lifestyle, awards, fame, notoriety and/or popularity.

A Register User is an individual, group or entity that has agreed to provided some metric data to the content library.

A Visitor/Guest is an individual, group or entity that visits a content library without actively agreeing to provide metric data. Note, a Visitor and/or Guest, depending on the set-up of the device connecting to the content library may also by default provide metric data that can be enhanced by proprietary profiling technology to the content library.

Population is a combination of at least one of guest/visitors and registered users.

Content Responders “CRs” shall mean a member of the population such as an individual, group or entity that provides CSC to the content library.

Filtering is a processes whereby a subset of DM in a content library, such as a DM in response to a C4C is narrowed as a function of the evaluation by one or more filterers. Filterer refers to a member of a population who meet a threshold filter criteria. Evaluation may include but is not limited to length of viewing, times viewed, numerical assignment, system, gauging, rating and judging, a numeric (objective) rating of content either simple numeric (no identity to screen out duplicate votes) or a verified numeric total (based on registered users and/or IP address). The filtering process includes subjective rating data based on likes and dislikes such as a determination of “worst” or “best” content.

Threshold filter criteria identifies filterers as a function of measurable variables including but is not limited to an IP subnet mask address, persons visiting the content library on a cell phone, persons with a certain ISP provider (not limited to all subnet classes), persons at one or more geographic locations identified by GPS, assisted GPS or other location gathering techniques, age, sex, alcohol level, temperature, credit rating, time, date, affiliation with a business, affiliation with a governmental entity, affiliation with a quasi-governmental entity, affiliation with a commercial entity, affiliation with a school, affiliation with a person, affiliation with a place, affiliation with a thing, legal proceedings (including but not limited to divorce, litigation, mediation, arbitration, bankruptcy).

Optionally, filtering may be performed independently or simultaneously by the moderator or proxy of the moderator (a committee) to perform administrative functions such as removal of DM content from a content library which does not respond to the specific prompt.

Filtered Content “FC” refers to a subset of a grouping or pool of DM content which includes all the responsive VADC posted or linked in a content library. One example of a filtered content is when a pool of category specific content is rated, promoted or included by the subset group.

Hot Topics refer, to a measure of trends. Hot topics are derived as a function of the activity of a web crawler on the internet. Trends may be measured in many different ways using a multitude of variables which include, but are not limited to metrics on internet, site activity, search terms, profiled user behavior, volume of traffic to one or more websites, news and keyword searches. The web crawler may perform activities including but not limited to audit, accumulation of popular and general open directory domain subfolders that track at least one of keywords, search terms, categorized postings, and phrases to build one or more lists, databases and/or LUTs.

High Interest Content means DM content generated on criteria as a function of one or more hot topics.

The web crawler may also include attaching a numerical value to hot topics as a function of a criteria which is used to approximate popularity of said hot topic.

In some implementations a user that is building a relevant pool of DM content on specific topic generates or obtains same from a population.

Filtering of a relevant pool of DM content that is submitted in response to a call for content may include a threshold filter criteria.

One or more filtered subsets from the pool of DM can be packaged, pushed, sent, provided, transmitted or otherwise made available for editing, use, advertisting and the like on television.

Other features and advantages of the present disclosure will be set forth, in part, in the descriptions which follow and the accompanying drawings, wherein the implementations of the present disclosure are described and shown, and in part, will become apparent to those skilled in the art upon examination of the following description taken in conjunction with the accompanying drawings or may be learned by practice of the present disclosure. The advantages of the present disclosure may be realized and attained by means of the instrumentalities and combinations particularly pointed out in the disclosure and any appended claims.

### BRIEF DESCRIPTION OF THE DRAWING

FIG. 1 is an overview flow diagram of an exemplary implementation of a process, product by process, method and system which can be used to perform at least one of seek out specific content, identify specific content, promote or initiate generation of specific content, filter such content, and provide filtered content for use by television, broadcasters.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DESCRIPTION

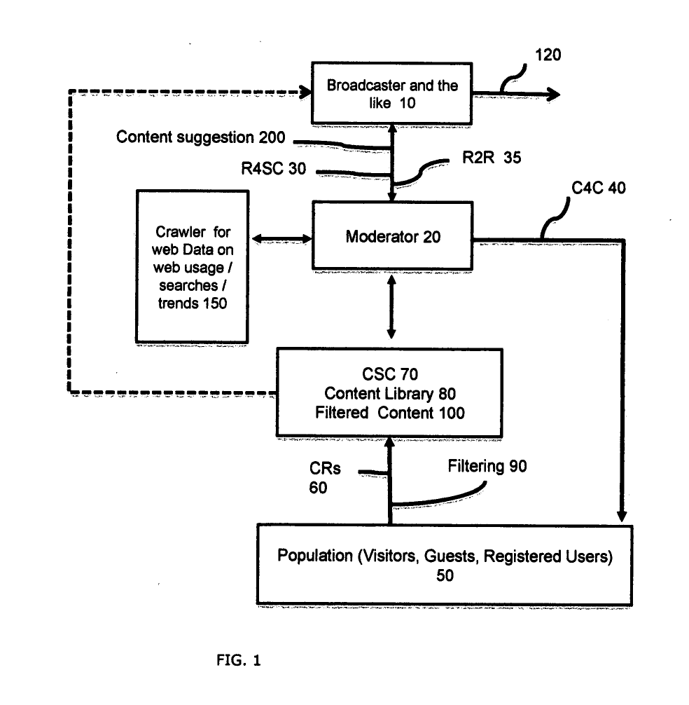

All call outs and text in FIG. 1 are hereby incorporated by this reference.

Shown in FIG. 1 shows an overview of a method, process and system to generate and collect DM content as a function of a promotion or request. It also shows an overview of providing a subset of said DM content for distribution as a function of filtering. In one aspect at least some of the collected content is filtered. In a another aspect filtered content is provided to broadcasters to be transmitted as television programming. In one aspect filtered content is made available for download (such as podcasting, Point to Point (P2P), and other similar means of transmission). The transmission, sharing and viewing of digital/analog media requires the use of one or more processors and/or devices designed for at least one of rendering, streaming, buffering and the viewing of content.

A broadcaster via a moderator (which may be an affiliate of the broadcaster) develops a request for specific content DM from a population, that request may be anyone with video or audio of a variety of topics including but not limited to wall street bankers spending money on escorts, a trainwreck in Montana, your story on how drinking Trainwreck™ the fortified beverage has caused your life to become a trainwreck, people texting while driving, and pigs flying. The moderator may refine the request.

At some point the request is transmitted so that members of a population can know of the request. Once known a population member may respond to the request by providing the requested content. Providing may be via a portal that distributes the DM content or direct to an archive or repository such as a website or servers connected to a website. The responsive content is generally considered the VADC (viewer accessible digital content). The posted or linked content (responses) are available to be viewed whereby gross metric such as numbers of hits are determined, Less gross metrics include filtering of DM content by a portion of a population (which may include using threshold filtering criteria) members and numerical data from viewing can be used to rate each content posting. A subset of posted content that appears to be responsive to a call for specific content is then made ready for at least one of evaluation for television broadcast. Or for television broadcast. In some instance the filtered ready for television DM content may be made available for download.

### In a First Example

Step One: Broadcaster 10 contacts moderator 20 and makes a request for specific content (R4SC) 30. A specific content request contains at least some criteria which at least identifies/defines a topic, genre, type, theme and/or summary of content sought.

Optional Step One B: The moderator communicates a request to refine 35 to the broadcaster 10 and the broadcaster communicates the refinement of the R4SC to the moderator 20.

Step Two: The moderator 20 processes the R4SC. Moderator processing includes, but is not limited to no changes or alteration, refinement, suggestions, additions and modifications of criteria and reductions of criteria.

Step Three: The moderator 20 communicates a call for content (C4C) 40 (prompted by the broadcaster's R4SC) to a population 50. Communication may be posting via internet, via cell phone, telephony, television or any other communications media device, including interactive and passive devices. Calls for content 40 may be video, textual, electroencephalography (“EEG”) or auditory.

### In a Second Example:

Step One: Broadcaster 10 contacts moderator 20 and makes a request for specific content (R4SC) 30. A specific content request contains at least some criteria which at least identifies/defines a topic, genre, type, theme and/or summary of content sought.

Step Two: The moderator communicates a request to refine 35 to the broadcaster 10 and the broadcaster communicates the refinement of the R4SC to the moderator 20.

Step Three: The moderator 20 communicates a call for content (C4C) 40 (prompted by the broadcaster's R4SC) to a population 50. Communication may be posting via internet, via cell phone, telephony, television or any other communications media device, including interactive and passive devices. Calls for content 40 may be video, textual, electroencephalography (“EEG”) or auditory.

Step Four: Population members who respond are respond to the call for content are content responders 60 and such content whether posted or linked DM are category specific content (CSC) 70 responses at a content library 80. Posted DM are rendered as required for posting and if linked are rendered as needed for access/viewing.

### In a Third Example

Step One: Broadcaster 10 contacts moderator 20 and makes a request for specific content (R4SC) 30. A specific content request contains at least some criteria which at least identifies/defines a topic, genre, type, theme and/or summary of content sought.

Step Two: The moderator 20 processes the R4SC. Moderator processing includes, but is not limited to no changes or alteration, refinement, suggestions, additions and modifications of criteria and reductions of criteria.

Step Three: The moderator 20 communicates a call for content (C4C) 40 (prompted by the broadcaster's R4SC) to a population 50. Communication may be posting via internet, via cell phone, telephony, television or any other communications media device, including interactive and passive devices. Calls for content 40 may be video, textual, electroencephalography (“EEG”) or auditory.

Step Four: Population members who respond to a C4C are content responders 60 and such content whether posted or linked DM are category specific content (CSC) 70 responses at a content library 80.

Optional Step Four B: Moderator 20 intercedes before, during or after a filtering to removes non-responsive content.

Step Five: Linked or posted responsive content is filtered 90 by at least one of the population, visitors, guests and registered users 50 of the content library 80, and the filtering may include a threshold filtering criteria.

### In a Fourth Example

Step One: Broadcaster 10 contacts moderator 20 and makes a request for specific content (R4SC) 30. A specific content request contains at least some criteria which at least identifies/defines a topic, genre, type, theme and/or summary of content sought.

Step Two: The moderator 20 processes the R4SC. Moderator processing includes, but is not limited to no changes or alteration, refinement, suggestions, additions and modifications of criteria and reductions of criteria.

Step Three: The moderator 20 communicates a call for content (C4C) 40 (prompted by the broadcaster's R4SC) to a population 50. Communication may be posting via internet, via cell phone, telephony, television or any other communications media device, including interactive and passive devices. Calls for content 40 may be video, textual, electroencephalography (“EEG”) or auditory.

Step Four: Population members who responded to a C4C are content responders 60 and such content whether posted or linked DM are category specific content (CSC) 70 responses at a content library 80.

Step Five: linked or posted responsive content which is VADC is filtered 90 by at least one of population, visitors, guests and registered users 50 of the content library 80 the process yielding filtered content 100 and the filtering may include a threshold filtering criteria.

Step Six: Filtered content 100 is communicated with or to the moderator 20.

Optional Step Six Alternate: Filtered content 100 is communicated directly from the content library 80 to the broadcaster 10.

### In a Fifth Example

Step One: Broadcaster 10 contacts moderator 20 and makes a request for specific content (R4SC) 30. A specific content request contains at least some criteria which at least identifies/defines a topic, genre, type, theme and/or summary of content sought.

Step Two: The moderator 20 processes the R4SC. Moderator processing includes, but is not limited to no changes or alteration, refinement, suggestions, additions and modifications of criteria and reductions of criteria.

Step Three: The moderator 20 communicates a call for content (C4C) 40 (prompted by the broadcaster's R4SC) to a population 50. Communication may be posting via internet, via cell phone, telephony, television or any other communications media device, including interactive and passive devices. Calls for content 40 may be video, textual, electroencephalography (“EEG”) or auditory.

Step Four: Population members who respond are respond to the C4C are content responders 60 and such content whether posted or linked DM are category specific content (CSC) 70 responses at a content library 80.

Step Five: linked or posted responsive content is filtered 90 by at least one of population, visitors, guests and registered users 50 of the content library 80 the process yielding filtered content 100 and the filtering may include a threshold filtering criteria.

Step Six: Filtered content 100 is communicated with or to the moderator 20.

Step Seven: The moderator communicates at least some of the filtered content 100 to the broadcaster 10.

### In a Sixth Example

Step One: Broadcaster 10 contacts moderator 20 and makes a request for specific content (R4SC) 30. A specific content request contains at least some criteria which at least identifies/defines a topic, genre, type, theme and/or summary of content sought.

Step Two: The moderator 20 processes the R4SC. Moderator processing includes, but is not limited to no changes or alteration, refinement, suggestions, additions and modifications of criteria and reductions of criteria. Step Three: The moderator 20 communicates a call for content (C4C) 40 (prompted by the broadcaster's R4SC) to a population 50. Communication may be posting via internet, via cell phone, telephony, television or any other communications media device, including interactive and passive devices. Calls for content 40 may be video, textual, electroencephalography (“EEG”) or auditory.

Step Four: Population members who to a C4C are content responders 60 and such content whether posted or linked DM are category specific content (CSC) 70 responses at a content library 80.

Step Five: linked or posted responsive content is filtered 90 by at least one of population, visitors, guests and registered users 50 of the content library 80 the process yielding filtered content 100 and the filtering may include a threshold filtering criteria.

Step Six: Filtered content 100 is communicated with or to the moderator 20.

Step Seven: The moderator communicates at least some of the filtered content 100 to the broadcaster 10.

Step Eight: The broadcaster transmits 120 at least some of the filtered content in programming.

### In a Seventh Example

Step One: A crawler for web data 150 and the moderator 20 communicate information on one or more hot topics. The communication may take the form of pre-planned reporting from the crawler 150 on criteria being searched that contains a certain topic. Alternatively the crawler may report a topic, trend, event, keyword, meta tag, terms searched as a function of meeting or exceeding a reporting threshold.

Step Two: The moderator 20 uses information from the crawler 150 to develop a call for content (C4C) 40.

Step Three: The moderator 20 communicates a call for content (C4C) 40 (prompted by the broadcaster's R4SC) to a population 50. Communication may be posting via internet, via cell phone, telephony, television or any other communications media device, including interactive and passive devices. Calls for content 40 may be video, textual, electroencephalography (“EEG”) or auditory.

Step Four: Population members who respond to a C$C r are content responders 60 and such content whether posted or linked DM are category specific content (CSC) 70 responses at a content library 80.

### In a Eighth Example

Step One: A crawler for web data 150 and the moderator 20 communicate information on one or more hot topics. The communication may take the form of pre-planned reporting from the crawler 150 on criteria being searched that contains a certain topic. Alternatively the crawler may report a topic, trend, event, keyword, meta tag, terms searched as a function of meeting or exceeding a reporting threshold.

Step Two: The moderator 20 uses information from the crawler 150 to develop a call for content (C4C) 40.

Step Three: The moderator 20 communicates a call for content (C4C) 40 to a population 50. Communication may be posting via internet, via cell phone, telephony, television or any other communications media device, including interactive and passive devices. Calls for content 40 may be video, textual, electroencephalography (“EEG”) or auditory.

Step Four: Population members who respond to a C4C are content responders 60 and such content whether posted or linked DM are category specific content (CSC) 70 responses at a content library 80.

Step Five: linked or posted responsive content is filtered 90 by at least one of population, visitors, guests and registered users 50 of the content library 80 the process yielding filtered content 100 and the filtering may include a threshold filtering criteria.

Step Six: The filtered content 100 is communicated with or to the Moderator 20.

Step Seven: The moderator communicates at least some of the filtered content 100 to the broadcaster 10.

Step Eight: The broadcaster transmits 120 at least some of the filtered content in programming.

### In a Ninth Example

Step One: A crawler for web data 150 and the moderator 20 communicate information on one or more hot topics. The communication may take the form of pre-planned reporting from the crawler 150 on criteria being searched that contains a certain topic. Alternatively the crawler may report a topic, trend, event, keyword, meta tag, terms searched as a function of meeting or exceeding a reporting threshold.

Step Two: The moderator 20 uses information from the crawler 150 to make a content suggestion 200 to the broadcaster for a specific content.

Step Three: The broadcaster contacts the moderator 20 and makes a request for specific content at least in part based on the content suggestion 200. A specific content request contains at least some criteria which at least identifies/defines a topic, genre, type, theme and/or summary of content sought.

Step Four: The moderator 20 uses information from the crawler 150 to develop a call for content (C4C) 40.

Step Five: The moderator 20 communicates a call for content (C4C) 40 (prompted by the broadcaster's R4SC) to a population 50. Communication may be posting via internet, via cell phone, telephony, television or any other communications media device, including interactive and passive devices. Calls for content 40 may be video, textual, electroencephalography (“EEG”) or auditory.

Step Six: Population members who respond to a C4C are content responders 60 and such content whether posted or linked DM are category specific content (CSC) 70 responses at a content library 80.

Step Seven: linked or posted responsive content is filtered 90 by at least one of population, visitors, guests and registered users 50 of the content library 80 the process yielding filtered content 100.

Step Eight: The filtered content 100 is communicated with or to the Moderator 20.

Step Nine: The moderator communicates at least some of the filtered content 100 to the broadcaster 10. The amount of content communicated to the broadcaster can be modulated by the use of a threshold filtering criteria.

Step Ten: The broadcaster transmits 120 at least some of the filtered content in programming

While the method and agent, have been described in terms of what are presently considered to be the most practical and preferred implementations, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclsoure. It should be understood that this disclosure is intended to yield a patent covering numerous aspects both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the implementation, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting, such statements are expressly not to be considered as made by the applicant(s).

In this regard it should be understood that for practical reasons and so as to avoid adding potentially hundreds of claims, the applicant has presented claims with initial dependencies only. We are presenting only one claim?

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternatives.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

All callouts associated with figures are hereby incorporated by this reference.

Since certain changes may be made in the above system, method, process and or apparatus without departing from the scope of the disclosure herein involved, it is intended that all matter contained in the above description, as shown in the accompanying drawing, shall be interpreted in an illustrative, and not a limiting sense.

We claim:

1. A process of generating digital media content for broad distribution, the process comprising steps of:
a request for specific content is generated;
said request for specific content is communicated to a population as a call for content which is to be posted or linked to an online digital content library; and,
as a function of the call for content at least some members of said population post or link at least one of category specific content and responsive DM content to said content library.

2. The process of claim 1 further comprising step of
at least some linked or posted DM content at the content library is filtered by at least one member of a population.

3. The process of claim 2 further comprising the step of a moderator being supplied content as a function of said filtering.

4. The content generating system of claim 3 wherein said moderator is also the broadcaster.

5. The content generating system of claim 3 wherein the moderator is not the broadcaster and communicates at least some of said filtered content to said broadcaster.

6. The content generating system of claim 5 wherein the broadcaster broadcasts at least some of said filtered content to viewers.

7. The system of claim 3 wherein said filtering includes using one or more threshold filtering criteria.

8. The system of claim 3 wherein the call for content is time limited and content may only be posted or linked within one or more periods.

9. A content generating process comprising the steps of:
a crawler for web data acquires information as a function of one or more defined hot topics;
the crawler delivers at least some hot topic to a moderator;
as a function of said defined hot topic said moderator issues one or more calls for content to a population;
as a function of the call for content at least some members of said population post or link content to a content library.

10. A system using trends to generate high interest content comprising the steps of:
a web crawler builds at least one of a LUT, list, group, table of hot topics;
the web crawler may also include attaching a numerical value to hot topics as a function of a criteria which is used to approximate popularity of said hot topic; and,
the web crawler reports the hot topic and numerical values to the moderator;
as a function of the information from the crawler the moderator issues one or more a calls for content to a population; as a function of the call for content at least some members of the population post or link DM content to a content library;
the moderator is supplied specific DM content as a function of filtering of the content library by at least one member of a population;
the moderator communicates at least some of the filtered DM content to the broadcaster; and,
the broadcaster broadcasts at least some of the filtered DM content.

11. The system of claim 10 further comprising step of
at least some linked or posted DM content at the content library is filtered by at least one member of a population

12. The system of claim 11 wherein said moderator is also the broadcaster.

13. The system of claim 11 wherein said filtering includes using one or more threshold filtering criteria.

14. The system of claim 13 wherein the call for content is time limited and category specific content may only be posted or linked within one or more periods.
